(19) United States
(12) Patent Application Publication
(10) Pub. No.: US 2024/0097130 A1
(43) Pub. Date: Mar. 21, 2024

(54) Lithium Secondary Battery and Manufacturing Method for the Same

(71) Applicant: NIPPON TELEGRAPH AND TELEPHONE CORPORATION, Tokyo (JP)

(72) Inventors: Hironobu Minowa, Musashino-shi, Tokyo (JP); Akihiro Kono, Musashino-shi, Tokyo (JP); Takeshi Komatsu, Musashino-shi, Tokyo (JP)

(21) Appl. No.: 18/256,611

(22) PCT Filed: Jan. 12, 2021
(86) PCT No.: PCT/JP2021/000653

§ 371 Date: Jun. 8, 2023

(51) Int. Cl. H01M 4/60; H01M 4/04; H01M 4/13; H01M 4/139; H01M 10/0525

(52) U.S. Cl. CPC H01M 4/60; H01M 4/0407; H01M 4/13; H01M 4/139; H01M 10/0525

(57) ABSTRACT

A lithium secondary battery includes: a positive electrode film formed on a transparent substrate having flexible electron conductivity and containing a substance capable of performing a redox reaction with lithium ions; a transparent electrolyte having lithium ion conductivity; and a negative electrode film formed on a transparent substrate having flexible electron conductivity and containing an organic radical species capable of performing a redox reaction with lithium ions.

### TECHNICAL FIELD

The present invention relates to a lithium secondary battery and a method for manufacturing the lithium secondary battery.

### BACKGROUND ART

A lithium ion secondary battery using a lithium ion insertion/removal reaction is widely used as a secondary battery having a high energy density in applications such as various electronic devices, automotive power supplies, and power storage. For the purpose of improving performance of the lithium ion secondary battery and reducing cost thereof, research and development of an electrode material and an electrolyte material have been advanced.

Recently, with development of IT devices such as a smartphone and IoT devices, a lithium secondary battery for a mobile power supply has attracted attention. New characteristics may be required for batteries for these devices in order to differentiate their products. As the new characteristics, for example, flexibility and the like are apparent.

A flexible lithium secondary battery has been reported in, for example, Non Patent Literature 1. The battery is reported to be thin and bendable, and to exhibit a discharge capacity of about 250 μAh/g at a discharge current with a current density of 0.1 mA/cm².

### CITATION LIST

### Non Patent Literature

Non Patent Literature 1: Masahiko Hayashi, et al., “Preparation and electrochemical properties of pure lithium cobalt oxide films by electron cyclotron resonance sputtering”, Journal of Power Sources 189 (2009) 416 to 422.

### SUMMARY OF INVENTION

### Technical Problem

Such a thin and bendable lithium secondary battery as described above has been studied. However, there is no report on a battery that transmits visible light. That is, if a battery having a visible light-transmitting property and flexibility can be achieved, it is possible to largely expand designability and the range of applications of an IoT device. However, there is a problem that such a battery does not yet exist.

The present invention has been made in view of this problem, and an object of the present invention is to provide a lithium secondary battery having both a transmitting property and flexibility, and a method for manufacturing the lithium secondary battery.

### Solution to Problem

A lithium secondary battery according to an aspect of the present invention includes: a positive electrode film formed on a transparent substrate having flexible electron conductivity and containing a substance capable of performing a redox reaction with lithium ions; a transparent electrolyte having lithium ion conductivity; and a negative electrode film formed on a transparent substrate having flexible electron conductivity and containing an organic radical species capable of performing a redox reaction with lithium ions.

A method for manufacturing a lithium secondary battery according to an aspect of the present invention includes: a step of forming a positive electrode film formed on a transparent substrate having flexible electron conductivity and containing a substance capable of performing a redox reaction with lithium ions; a step of forming a negative electrode film formed on a transparent substrate having flexible electron conductivity and containing an organic radical species capable of performing a redox reaction with lithium ions; and a step of forming a transparent electrolyte film having lithium ion conductivity.

### Advantageous Effects of Invention

The present invention can provide a lithium secondary battery having both a transmitting property and flexibility and a method for manufacturing the lithium secondary battery.

### BRIEF DESCRIPTION OF DRAWINGS

FIG. 1A is a plan view illustrating a configuration of a lithium secondary battery according to the present embodiment.

FIG. 1B is a side view illustrating the configuration of the lithium secondary battery according to the present embodiment.

FIG. 2 is a flowchart illustrating a procedure for manufacturing the lithium secondary battery.

FIG. 3 is a diagram illustrating an example of charge/discharge characteristics of a lithium secondary battery of Experimental Example 1.

FIG. 4 is a diagram illustrating an example of charge/discharge cycle characteristics of the lithium secondary battery of Experimental Example 1.

FIG. 5 is a diagram illustrating an example of light-transmitting characteristics of the lithium secondary battery of Experimental Example 1.

FIG. 6 is a diagram illustrating an example of charge/discharge characteristics of a lithium secondary battery of Experimental Example 2.

FIG. 7 is a diagram illustrating an example of charge/discharge cycle characteristics of the lithium secondary battery of Experimental Example 2.

FIG. 8 is a diagram illustrating an example of light-transmitting characteristics of the lithium secondary battery of Experimental Example 2.

### DESCRIPTION OF EMBODIMENTS

Hereinafter, an embodiment of the present invention will be described with reference to the drawings.

### Configuration of Lithium Secondary Battery

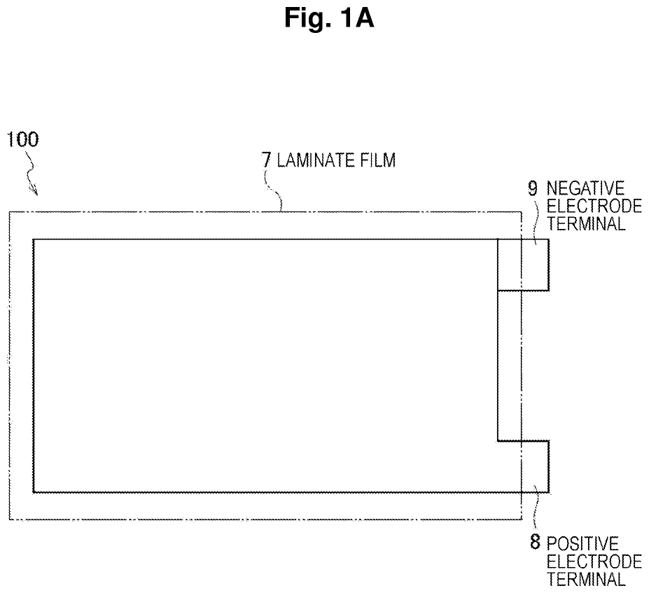

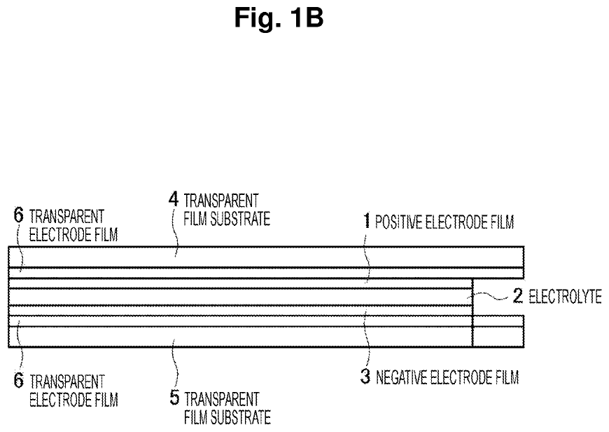

FIGS. 1A and 1B are schematic diagrams illustrating a basic configuration example of a lithium secondary battery according to the present embodiment. FIG. 1A is a plan view, and FIG. 1B is a side view.

As illustrated in FIGS. 1A and 1B, a lithium secondary battery 100 according to the present embodiment is, for example, a rectangular flat plate, in which flexible transparent film substrates 4 and 5 having a visible light-transmitting property are vertically sandwiched between laminate films 7, and the laminate films 7 are thermocompression-bonded to each other. At least a positive electrode, an electrolyte, and a negative electrode are disposed between the laminate films 7. Note that the planar shape of the lithium secondary battery 100 is not limited to a rectangle.

As illustrated in FIG. 1A, a positive electrode terminal 8 and a negative electrode terminal 9 each having a quadrangular shape in plan view protrude to the outside of the laminate films 7 from both end portions of one short side of each of the rectangular transparent film substrates 4 and 5. A current can be extracted from between the positive electrode terminal 8 and the negative electrode terminal 9. The positive electrode terminal 8 and the negative electrode terminal 9 may be formed by extending a transparent electrode film 6 described later, or may be made of metal.

The lithium secondary battery 100 illustrated in FIG. 1B includes a positive electrode film 1, an electrolyte 2, a negative electrode film 3, the transparent electrode film 6, and the transparent film substrates (transparent substrates) 4 and 5.

The positive electrode film 1 is formed on a transparent substrate having flexible electron conductivity and contains a substance capable of performing a redox reaction (oxidation-reduction reaction) with lithium ions. Specifically, the positive electrode film 1 is formed by forming a film of a substance capable of performing a redox reaction with lithium ions in a predetermined thickness on the transparent electrode film 6 such as ITO formed on the entire one surface of the flexible transparent film substrate 4. In a case where a lithium source is contained in the negative electrode film 3, the positive electrode film 1 may contain an organic radical species as a substance capable of performing a redox reaction.

The negative electrode film 3 is formed on a transparent substrate having flexible electron conductivity and contains organic radical species capable of performing a redox reaction with lithium ions. Specifically, similarly to the positive electrode film 1, the negative electrode film 3 is formed by forming a film of a substance capable of performing a redox reaction with lithium ions in a predetermined thickness on the transparent electrode film 6 such as ITO formed on the entire one surface of the transparent film substrate 5. As the substance capable of performing a redox reaction in the negative electrode film 3 of the present embodiment, an organic radical species may be used. For example, the negative electrode film 3 may contain at least one organic radical species selected from the group consisting of anthraquinone and phthalimide.

Note that the substance capable of performing a redox reaction with lithium ions is, for example, a substance capable of inserting and removing lithium ions or a substance capable of dissolving and precipitating lithium.

The transparent film substrates 4 and 5 are flexible transparent substrates. The transparent film substrates 4 and 5 are made of the same substance, and may be made of, for example, polyethylene terephthalate (PET).

The positive electrode film 1 and the negative electrode film 3 are disposed so as to face each other with the electrolyte 2 interposed therebetween. As the electrolyte 2, a transparent electrolyte having lithium ion conductivity is used. Specifically, as the electrolyte 2, an organic electrolyte, an aqueous electrolytic solution, and the like each containing lithium ions can be used as long as they are conventional substances having lithium ion conductivity and having no electron conductivity, and further have a visible light-transmitting property.

In addition, conventional solid-state electrolytes such as a solid electrolyte and a polymer electrolyte each containing lithium ions can also be used as long as they transmit visible light.

Note that a separator (not illustrated) may be included between the positive electrode film 1 and the negative electrode film 3. Examples of a separator having a light-transmitting property include polyethylene (PE), polypropylene (PP), and an ion-exchange membrane. When an organic electrolyte or an aqueous electrolyte is used as the electrolyte 2, for example, the separator may be impregnated with the electrolyte 2.

In addition, the organic electrolyte or the aqueous electrolyte may be impregnated with a polymer electrolyte or the like. In addition, when a solid electrolyte, a polymer electrolyte, or the like is used, both the positive electrode film 1 and the negative electrode film 3 only need to be disposed so as to be in contact with the solid electrolyte, the polymer electrolyte, or the like.

As described above, the lithium secondary battery 100 of the present embodiment includes: the positive electrode film 1 formed on the transparent film substrate 4 having flexible electron conductivity and containing a substance capable of performing a redox reaction with lithium ions; the transparent electrolyte 2 having lithium ion conductivity; and the negative electrode film 3 formed on the transparent film substrate 5 having flexible electron conductivity and containing an organic radical species capable of performing a redox reaction with lithium ions.

This makes it possible to provide a lithium secondary battery having both a visible light-transmitting property and flexibility.

### Experimental Example 1

Method for Manufacturing Lithium Secondary Battery

A lithium secondary battery of Experimental Example 1 is a lithium secondary battery in a case where a lithium source is contained in the positive electrode film 1, in which an organic radical species used for the negative electrode film 3 contains at least one selected from the group consisting of anthraquinone and phthalimide. Here, a lithium secondary battery using anthraquinone for the negative electrode film 3 and a lithium secondary battery using anthraquinone for the negative electrode film 3 are manufactured.

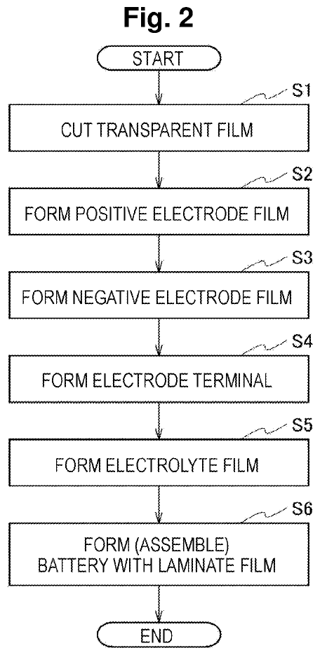

FIG. 2 is a flowchart illustrating a procedure for manufacturing the lithium secondary battery of Experimental Example 1 of the present embodiment. A method for manufacturing the lithium secondary battery will be described with reference to FIG. 2.

First, each of the transparent film substrates 4 and 5 to be a substrate on which an electrode film is formed is cut into a predetermined size (step S1). The size of each of the transparent film substrates 4 and 5 is, for example, about 100 mm in length×50 mm in width.

Next, the positive electrode film 1 is formed (step S2). In forming the positive electrode film 1, the transparent electrode film 6 is formed on a surface of the transparent film substrate 4.

The transparent electrode film 6 was formed by coating the surface of the transparent film substrate 4 with ITO in a thickness of 150 nm by an RF sputtering method. Sputtering was performed at an RF power of 100 W using an ITO (5 wt % SnO₂) target while argon (1.0 Pa) was allowed to flow.

Next, as the positive electrode film 1, for example, a film of lithium cobalt oxide (LiCoO₂) used in a conventional lithium ion battery was formed on the transparent electrode film 6 by an RF sputtering method in a thickness of 100 nm (the film thickness is desirably 200 nm or less in consideration of a visible light-transmitting property). The positive electrode film 1 was formed using a ceramic target of LiCoO₂ under conditions of a flow partial pressure ratio between argon and oxygen of 3:1, a total gas thickness of 3.7 Pa, and an RF output of 600 W. Note that a portion of the transparent electrode film 6 having a size of 10 mm in length×50 mm in width was masked, and the positive electrode film 1 was formed in an unmasked portion having a size of 90 mm in length×50 mm in width.

Next, the negative electrode film 3 is formed (step S3). In a similar manner to the positive electrode film 1, first, the transparent electrode film 6 was formed on a surface of the transparent film substrate 5. For the negative electrode film 3, anthraquinone powder or phthalimide powder is mixed with an N-methyl-2-pyrrolidone (NMP) solvent at a weight ratio of 4:1, and the resulting mixture is stirred until the anthraquinone powder or the phthalimide powder is completely dissolved therein, thus generating a solution. A portion of the transparent electrode film 6 (ITO film) having a size of 10 mm in length×50 mm in width, formed on the transparent film substrate 5 was masked. The solution was applied to an unmasked region having a size of 90 mm in length×50 mm in width, and dried in dry air with a dew point of −50° C. or lower at room temperature for 48 hours to form the flexible negative electrode film 3 polymerized using only an organic material. Here, two types (anthraquinone and phthalimide) of electrode films 3 were formed on the transparent film substrates 5 on which the transparent electrode films 6 were formed, respectively.

Anthraquinone and phthalimide are stable organic radical anion species (A_{rad}), have a very high visible light-transmitting property, have high flexibility, and have a low potential as an electrode material, and thus are promising as negative electrode materials.

As a battery reaction, electrons e− from the positive electrode are received at the time of charging, radicals are charged into anions in such a manner as [A_{rad}]+ne−→[A_{rad}]ⁿ⁻, and the opposite reaction occurs at the time of discharging.

The positive electrode film 1 and the negative electrode film 3 have the same size of, for example, 90 mm in length×50 mm in width. The size of each of the positive electrode film 1 and the negative electrode film 3 may be smaller than that of the transparent electrode film 6.

Next, the electrode terminals 8 and 9 are formed (step S4). As described above, in each of the transparent film substrates 4 and 5 on which the positive electrode film 1 or the negative electrode film 3 is formed, there is a portion where the positive electrode film 1 or the negative electrode film 3 is not formed and the transparent electrode film 6 is exposed by a size of 10 mm in length×50 mm in width. In this portion of each of the transparent film substrates 4 and 5, a portion having a size of 10 mm in length×40 mm in width is cut out, and a portion having a size of 10 mm in length×10 mm in width at an end portion is left as the positive electrode terminal 8 or the negative electrode terminal 9.

Next, a film of the electrolyte 2 is formed (step S5). For the electrolyte 2, a solution obtained by mixing polyvinylidene fluoride (PVdF) powder as a binding material, an organic electrolytic solution obtained by dissolving 1 mol/L lithium bistrifluoromethanesulfonylimide (LiTFSI) as a lithium salt in propylene carbonate (PC), and N-methyl-2-pyrrolidone (NMP) as a dispersion medium at a weight ratio of 1:9:10 was stirred at 60° C. for one hour in dry air with a dew point of −50° C. or lower, and 50 ml of the solution was poured into a 200 mmφ petri dish and vacuum-dried at 50° C. for 12 hours to prepare the electrolyte 2 formed of a transparent film having a thickness of 300 μm.

Next, a battery is assembled (step S6). The transparent film substrate 4 on which the positive electrode film 1 is formed, the transparent film substrate 5 on which the negative electrode film 3 is formed, and the electrolyte 2 are laminated in a direction in which the positive electrode film 1 and the negative electrode film 3 face each other with the electrolyte 2 interposed therebetween. Then, the positive electrode terminal 8 and the negative electrode terminal 9 are sandwiched between the two laminate films 7 each having a size of 110 mm in length×70 mm in width×50 μm in thickness so as to be exposed to the outside, and the resulting product is hot-pressed at 100° C.

As described above, the method for manufacturing the lithium secondary battery of Experimental Example 1 includes: a step of forming the positive electrode film 1 formed on a transparent substrate having flexible electron conductivity and containing a substance capable of performing a redox reaction with lithium ions; a step of forming the negative electrode film 3 formed on a transparent substrate having flexible electron conductivity and containing an organic radical species capable of performing a redox reaction with lithium ions; and a step of forming a transparent electrolyte film having lithium ion conductivity.

Charge/Discharge Test

Charge/discharge characteristics of the lithium secondary battery of Experimental Example 1 prepared by the above manufacturing method were measured. A charge/discharge test was performed using a general charge/discharge system. As charge conditions, a current was allowed to flow at a current density of 1 μA/cm² per effective area of the positive electrode film 1, and an end-of-charge voltage was set to 2.5 V.

In addition, as discharge conditions, discharge was performed at a current density of 1 μA/cm², and an end-of-discharge voltage was set to 0.5 V. The charge/discharge test was performed in a thermostatic chamber at 25° C. (atmosphere: a normal air environment).

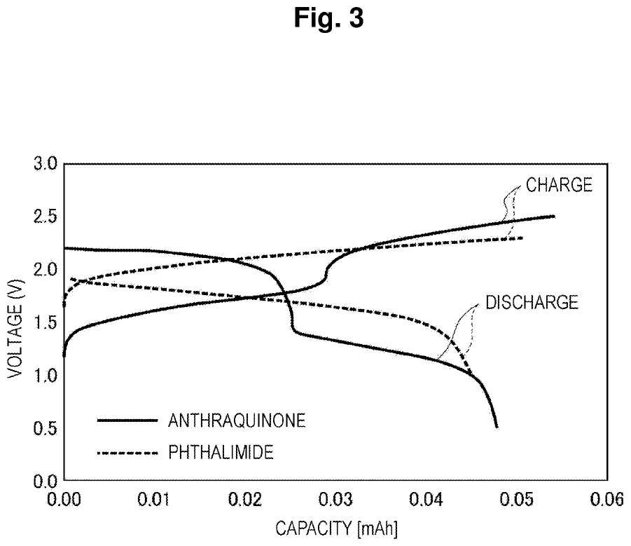

FIG. 3 is a diagram illustrating charge/discharge characteristics of the lithium secondary battery. In FIG. 3, the horizontal axis represents a discharge capacity [mAh], and the vertical axis represents a battery voltage [V]. In FIG. 3, the solid lines indicate charge characteristics and discharge characteristics of the lithium secondary battery using anthraquinone for the negative electrode film 3. The broken lines indicate charge characteristics and discharge characteristics of the lithium secondary battery using phthalimide for the negative electrode film 3.

As illustrated in FIG. 3, in a case of using anthraquinone, the discharge capacity was about 0.048 mAh, and two-stage flat portions were confirmed for the average discharge voltage, which were about 2.1 V and 1.2 V, respectively. This is considered to be because anthraquinone is a divalent anion, and the first stage is a reaction of [A_{rad}]+e−→[A_{rad}]⁻, and the second stage is a reaction of [A_{rad}]⁻+e−→[A_{rad}]²⁻. In a case of using phthalimide, the discharge capacity was about 0.045 mAh, and the average discharge voltage was about 1.7 V.

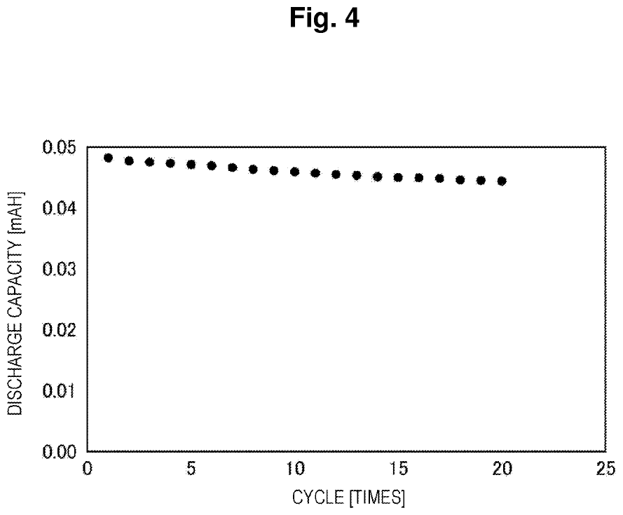

FIG. 4 is a diagram illustrating charge cycle characteristics of the lithium secondary battery using anthraquinone for the negative electrode film 3. In FIG. 4, the horizontal axis represents the number of charge/discharge cycles [times], and the vertical axis represents a discharge capacity [mAh].

As illustrated in FIG. 4, a decrease in discharge capacity after 20 cycles is about 0.004 mAh, and it can be seen that the lithium secondary battery has stable charge cycle characteristics.

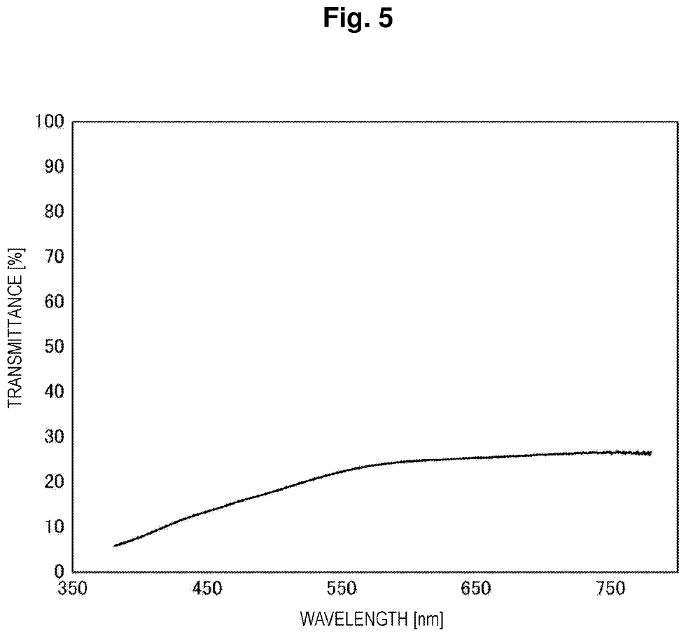

FIG. 5 is a diagram illustrating light-transmitting characteristics of the lithium secondary battery using anthraquinone for the negative electrode film 3. In FIG. 5, the horizontal axis represents a wavelength [nm] of light, and the vertical axis represents a transmittance [%] of light.

As illustrated in FIG. 5, the lithium secondary battery as a whole transmits light in a wavelength range (about 380 nm to 780 nm) of visible light. At a wavelength of 600 nm, the lithium secondary battery transmits about 25% of light (on the order of a pair of dark sunglasses).

As described above, the lithium secondary battery of Experimental Example 1 has stable charge/discharge cycle characteristics and light-transmitting characteristics.

In addition, the lithium secondary battery of Experimental Example 1 has flexibility because the positive electrode film 1 and the negative electrode film 3 are formed on the flexible transparent film substrates 4 and 5, respectively.

### Experimental Example 2

Method for Manufacturing Lithium Secondary Battery

A lithium secondary battery of Experimental Example 2 is a lithium secondary battery in a case where a lithium source is contained in the negative electrode film 3, in which an organic radical species is contained in a substance capable of performing a redox reaction with lithium ions in the positive electrode film 1. The organic radical species used for the positive electrode film 1 is, for example, 2,2,6,6-tetramethylpiperidine 1-oxyl (hereinafter, “TEMPO”) or a TEMPO derivative.

A positive electrode film 1A (another positive electrode film) of Experimental Example 2 is formed as follows. In a similar manner to Experimental Example 1, first, the transparent electrode film 6 was formed on a surface of a transparent film substrate 4A (another transparent film substrate). For the positive electrode film 1, TEMPO powder is mixed with an N-methyl-2-pyrrolidone (NMP) solvent at a weight ratio of 4:1, and the resulting mixture is stirred until the TEMPO powder is completely dissolved therein, thus generating a solution.

A portion of the transparent electrode film 6 (ITO film) having a size of 10 mm in length×50 mm in width, formed on the transparent film substrate 4A was masked. The solution was applied to an unmasked region having a size of 90 mm in length×50 mm in width, and dried in dry air with a dew point of −50° C. or lower at room temperature for 48 hours to form the flexible positive electrode film 1A polymerized using only an organic material. The positive electrode terminal 8 was formed on the transparent film substrate 4A on which the positive electrode film 1A was formed in a similar manner to Example 1.

TEMPO is a stable organic radical cation species (C_{rad}), has a very high visible light-transmitting property, has high flexibility, and has a high potential as an electrode material, and thus is promising as a positive electrode material.

In Experimental Example 2, TEMPO is used for the positive electrode film 1A, but a TEMPO derivative may be used instead of TEMPO. The TEMPO derivative is, for example, a material obtained by introducing various substituents into a 4-position as described below. A method for preparing the positive electrode film 1A using the TEMPO derivative is similar to that using TEMPO.
4 Cyano 2,2,6,6-tetramethylpiperidine 1-oxyl
4 Amino 2,2,6,6-tetramethylpiperidine 1-oxyl
4 Hydroxy 2,2,6,6-tetramethylpiperidine 1-oxyl
4 Oxo 2,2,6,6-tetramethylpiperidine 1-oxyl
4 Carboxy 2,2,6,6-tetramethylpiperidine 1-oxyl
4 Methoxy 2,2,6,6-tetramethylpiperidine 1-oxyl
4 Acetamide 2,2,6,6-tetramethylpiperidine 1-oxyl
4 Isothiocyano 2,2,6,6-tetramethylpiperidine 1-oxyl

The positive electrode film 1A may contain at least one organic radical species selected from the group consisting of TEMPO and a TEMPO derivative.

As a battery reaction, electrons e− from the negative electrode are released at the time of discharging, radicals are charged into cations in such a manner as [C_{rad}]→[C_{rad}]ⁿ⁺+ne−, and the opposite reaction occurs at the time of discharging.

In addition, a battery cell was prepared using the positive electrode film 1, the negative electrode film 3, and the electrolyte 2 prepared in a similar manner to the manufacturing method of Experimental Example 1 (FIG. 2: S1 to S5). In Experimental Example 2, anthraquinone was used for the negative electrode film 3.

Specifically, the transparent film substrate 4 on which the transparent electrode film 6 and the positive electrode film 1 were formed, the transparent film substrate 5 on which the transparent electrode film 6 and the negative electrode film 3 were formed, and the electrolyte 2 were laminated in a direction in which the positive electrode film 1 and the negative electrode film 3 faced each other with the electrolyte 2 interposed therebetween, thus preparing a battery cell.

Then, a current was allowed to flow at a current density of 1 μA/cm² per effective area of the positive electrode film 1 while the battery cell is pressed at room temperature such that the positive electrode terminal 8 and the negative electrode terminal 9 of the battery cell are outside a pressing machine, and the battery cell is charged to an end-of-charge voltage of 2.5 V to add the lithium source of the positive electrode film 1 to the negative electrode film 3. As a result, the negative electrode film 3 containing the lithium source can be generated.

Thereafter, the battery cell is taken out from the pressing machine, the transparent film substrate 4 on which the positive electrode film 1 is formed is peeled off from the battery cell, and the transparent film substrate 4 is replaced with the transparent film substrate 4A on which the above-described positive electrode film 1A is formed. The battery cell obtained by replacing the positive electrode film 1 with the positive electrode film 1A was sandwiched between the laminate films 7 each having a size of 110 mm in length×70 mm in width×50 μm in thickness such that the positive electrode terminal 8 and the negative electrode terminal 9 were exposed to the outside, and the resulting product was hot-pressed at 100° C. to manufacture the lithium secondary battery of Experimental Example 2.

As described above, in a similar manner to Experimental Example 1, the method for manufacturing the lithium secondary battery of Experimental Example 2 includes: a step of forming the positive electrode film 1 formed on a transparent substrate having flexible electron conductivity and containing a substance capable of performing a redox reaction with lithium ions; a step of forming the negative electrode film 3 formed on a transparent substrate having flexible electron conductivity and containing an organic radical species capable of performing a redox reaction with lithium ions; and a step of forming the transparent electrolyte 2 having lithium ion conductivity. Furthermore, the manufacturing method of Experimental Example 2 includes: a step of charging a battery cell using the positive electrode film 1, the electrolyte 2, and the negative electrode film 3 to add a lithium source of the substance to the negative electrode film 3; and a step of replacing the positive electrode film 1 of the battery cell with the other positive electrode film 1A containing at least one organic radical species selected from the group consisting of TEMPO and a TEMPO derivative.

Charge/Discharge Test

Charge/discharge characteristics of the lithium secondary battery of Experimental Example 2 prepared by the above manufacturing method were measured. A charge/discharge test was performed using a general charge/discharge system. As charge conditions, a current was allowed to flow at a current density of 1 μA/cm² per effective area of the positive electrode film 1A, and an end-of-charge voltage was set to 2.5 V.

In addition, as discharge conditions, discharge was performed at a current density of 1 μA/cm², and an end-of-discharge voltage was set to 0.5 V. The charge/discharge test was performed in a thermostatic chamber at 25° C. (atmosphere: a normal air environment).

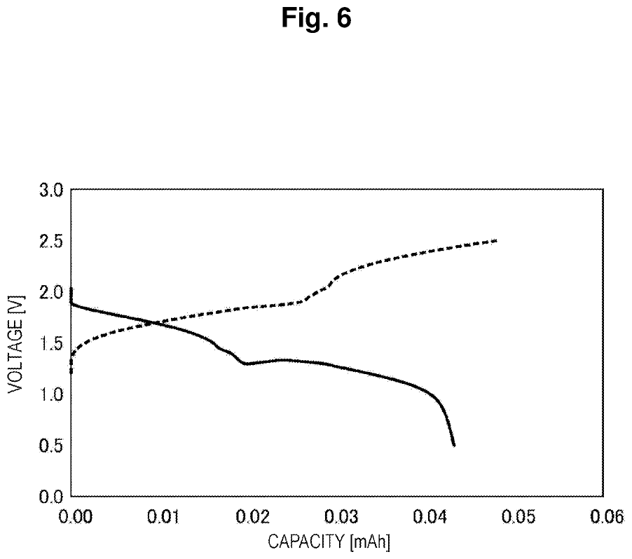

FIG. 6 is a diagram illustrating charge/discharge characteristics of the lithium secondary battery of Experimental Example 2. In FIG. 6, the horizontal axis represents a discharge capacity [mAh], and the vertical axis represents a battery voltage [V]. In FIG. 6, the solid line indicates discharge characteristics, and the broken line indicates charge characteristics.

As illustrated in FIG. 6, the discharge capacity was about 0.043 mAh, and two-stage flat portions were confirmed for the average discharge voltage, which were about 1.7 V and 1.3 V, respectively.

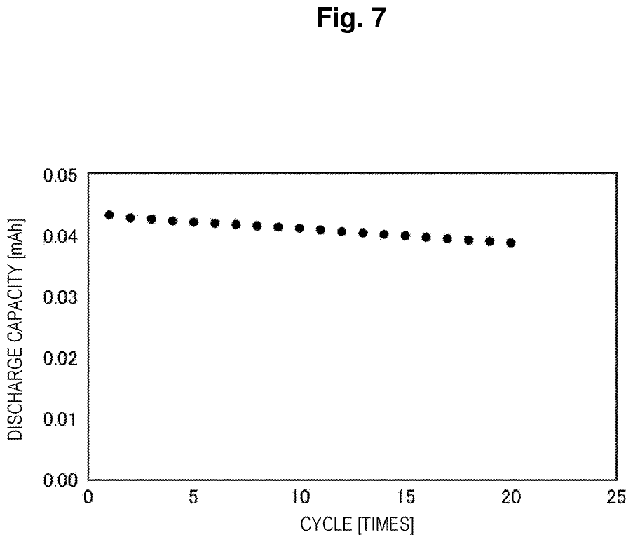

FIG. 7 is a diagram illustrating charge cycle characteristics of the lithium secondary battery of Experimental Example 2. In FIG. 7, the horizontal axis represents the number of charge/discharge cycles [times], and the vertical axis represents a discharge capacity [mAh].

As illustrated in FIG. 7, a decrease in discharge capacity after 20 cycles is about 0.004 mAh, and it can be seen that the lithium secondary battery has stable charge cycle characteristics.

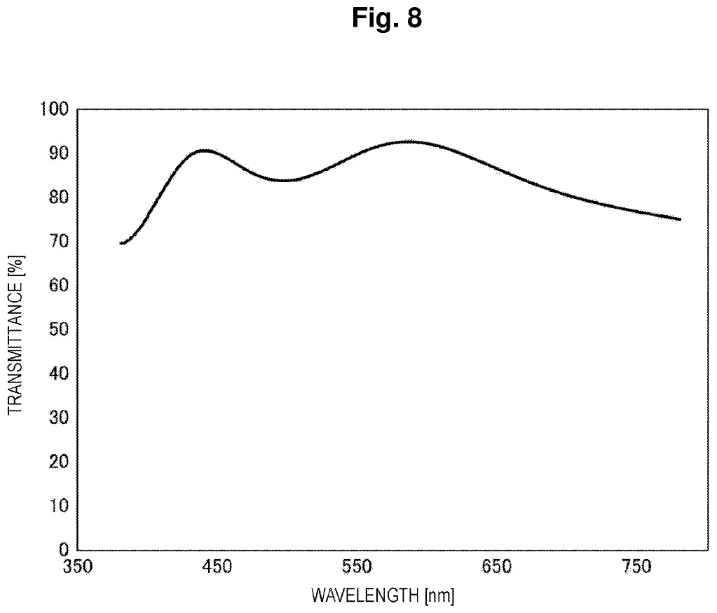

FIG. 8 is a diagram illustrating light-transmitting characteristics of the lithium secondary battery of Experimental Example 2. In FIG. 8, the horizontal axis represents a wavelength [nm] of light, and the vertical axis represents a transmittance [%] of light.

As illustrated in FIG. 8, the lithium secondary battery as a whole has a high light-transmitting property in a wavelength range (about 380 nm to 780 nm) of visible light. At a wavelength of 600 nm, the lithium secondary battery transmits about 92% of light. This is because use of an organic material for both the positive electrode and the negative electrode makes the electrodes transparent and improves a light-transmitting property.

As described above, the lithium secondary battery of Experimental Example 2 has stable charge/discharge cycle characteristics and light-transmitting characteristics.

In addition, the lithium secondary battery of Experimental Example 2 has flexibility because the positive electrode film 1A and the negative electrode film 3 are formed on the flexible transparent film substrates 4 and 5, respectively.

According to the present embodiment described above, a lithium secondary battery having both a transmitting property and flexibility can be prepared, and the lithium secondary battery can be used as a power source for various electronic devices.

Note that the present invention is not limited to the above embodiment, and modifications can be made within the scope of the gist of the present invention.

### REFERENCE SIGNS LIST

1 Positive electrode film
2 Electrolyte
3 Negative electrode film
4, 5 Transparent film substrate
6 Transparent electrode film
7 Laminate film
8 Positive electrode terminal
9 Negative electrode terminal
100 Lithium secondary battery

1. A lithium secondary battery comprising:
a positive electrode film formed on a transparent substrate having flexible electron conductivity and containing a substance capable of performing a redox reaction with lithium ions;
a transparent electrolyte having lithium ion conductivity; and
a negative electrode film formed on a transparent substrate having flexible electron conductivity and containing an organic radical species capable of performing a redox reaction with lithium ions.

2. The lithium secondary battery according to claim 1, wherein
the organic radical species of the negative electrode film contains at least one selected from the group consisting of anthraquinone and phthalimide.

3. The lithium secondary battery according to claim 1, wherein
in a case where a lithium source is contained in the negative electrode film,
the substance of the positive electrode film contains at least one organic radical species selected from the group consisting of 2,2,6,6-tetramethylpiperidine 1-oxyl (TEMPO) and a 2,2,6,6-tetramethylpiperidine 1-oxyl (TEMPO) derivative.

4. A method for manufacturing a lithium secondary battery, comprising:
a step of forming a positive electrode film formed on a transparent substrate having flexible electron conductivity and containing a substance capable of performing a redox reaction with lithium ions;
a step of forming a negative electrode film formed on a transparent substrate having flexible electron conductivity and containing an organic radical species capable of performing a redox reaction with lithium ions; and
a step of forming a transparent electrolyte film having lithium ion conductivity.

5. The method for manufacturing a lithium secondary battery according to claim 4, further comprising:
a step of charging a battery cell using the positive electrode film, the electrolyte, and the negative electrode film to add a lithium source of the substance to the negative electrode film; and
a step of replacing the positive electrode film of the battery cell with another positive electrode film containing at least one organic radical species selected from the group consisting of 2,2,6,6-tetramethylpiperidine 1-oxyl (TEMPO) and a 2,2,6,6-tetramethylpiperidine 1-oxyl (TEMPO) derivative.

6. The lithium secondary battery according to claim 2, wherein
in a case where a lithium source is contained in the negative electrode film,
the substance of the positive electrode film contains at least one organic radical species selected from the group consisting of 2,2,6,6-tetramethylpiperidine 1-oxyl (TEMPO) and a 2,2,6,6-tetramethylpiperidine 1-oxyl (TEMPO) derivative.
